(19) United States
(12) Patent Application Publication
(10) Pub. No.: US 2022/0284109 A1
(43) Pub. Date: Sep. 8, 2022

(54) BACKDOOR INSPECTION APPARATUS, BACKDOOR INSPECTION METHOD, AND NON-TRANSITORY COMPUTER READABLE MEDIUM

(71) Applicant: NEC Corporation, Minato-ku,Tokyo (JP)

(72) Inventors: Takayuki SASAKI, Tokyo (JP); Yusuke SHIMADA, Tokyo (JP)

(73) Assignee: NEC Corporation, Minato-ku,Tokyo (JP)

(21) Appl. No.: 17/636,417

(22) PCT Filed: Aug. 27, 2019
(86) PCT No.: PCT/JP2019/033409

§ 371 Date: Feb. 18, 2022

(51) Int. Cl. G06F 21/57; G06F 8/75

(52) U.S. Cl. CPC G06F 21/577; G06F 8/75; G06F 2221/033

(57) ABSTRACT

In a backdoor inspection apparatus, a specifying unit specifies a plurality of functional blocks respectively corresponding to a plurality of functions included in a target software. Inspection units executes inspection processing for each different type of backdoors. A distribution unit inputs the functional blocks specified by the specifying unit to at least some of the inspection units according to functions corresponding to each functional block specified by the specifying unit.

### TECHNICAL FIELD

The present disclosure relates to a backdoor inspection apparatus, a backdoor inspection method, and a non-transitory computer readable medium.

### BACKGROUND ART

Infrastructure and enterprise systems are becoming more complex. For this reason, infrastructure and enterprise systems are not constructed by devices procured from only a single enterprise, and instead are constructed by devices externally procured from various enterprises and combining them.

Recently, however, a number of incidents have been reported in which hidden functions of both software (firmware) and hardware not known to a user or not expected by a user are discovered in these devices. That is, a number of incidents related to “backdoors” have been reported. The “backdoor” may be defined, for example, as a function that is not known to a user and is not desired by a user, and that is incorporated as part of software including a plurality of functions.

There are various types of backdoors. A method for detecting a specific type of backdoor is disclosed, for example, in Non Patent Literature 1.

### CITATION LIST

### Non Patent Literature

Patent Literature 1: F. Schuster and T. Holz, “Towards reducing the attack surface of software backdoors”, In Proceedings of the 2013 ACM SIGSAC conference on Computer & communications security (CCS), 2013.

### PATENT LITERATURE

Patent Literature 1: Published Japanese Translation of PCT International Publication for Patent Application, No. 2010-541084
Patent Literature 2: Japanese Unexamined Patent Application Publication No. 2001-142720

### SUMMARY OF INVENTION

### Technical Problem

The present inventors have found that when all of a plurality of detection methods proposed for each of a plurality of types of backdoors are simply applied to software to be inspected, wasteful inspection processing may occur, resulting in poor processing efficiency and, further, poor inspection accuracy.

The present inventors have also found that when the entire software to be inspected is always inspected, it may take a long time for the inspection.

An object of the present disclosure is to provide a backdoor inspection apparatus, a backdoor inspection method, and a non-transitory computer readable medium capable of improving inspection efficiency for backdoors.

### Solution to Problem

In a first example aspect, a backdoor inspection apparatus includes:

specifying means for specifying a plurality of functional blocks respectively corresponding to a plurality of functions included in software to be inspected;

a plurality of inspection means for executing inspection processing for each different type of backdoors on the input functional blocks; and

distribution means for inputting the specified functional blocks to at least some of the plurality of inspection means according to functions corresponding to the specified functional blocks.

In a second example aspect, a backdoor inspection method executed by a backdoor inspection apparatus includes:

specifying a plurality of functional blocks respectively corresponding to a plurality of functions included in software to be inspected;

inputting the specified functional blocks to at least some of a plurality of inspection means of the backdoor inspection apparatus according to functions corresponding to the specified functional blocks; and

executing, by the plurality of inspection means, inspection processing for each different type of backdoors on the input functional blocks.

In a third example aspect, a non-transitory computer readable medium storing a program for causing a backdoor inspection apparatus to execute:

specifying a plurality of functional blocks respectively corresponding to a plurality of functions included in software to be inspected;

inputting the specified functional blocks to at least some of a plurality of inspection means of the backdoor inspection apparatus according to functions corresponding to the specified functional blocks; and

executing, by the plurality of inspection means, inspection processing for each different type of backdoors on the input functional blocks.

### Advantageous Effects of Invention

According to the present disclosure, it is possible to provide a backdoor inspection apparatus, a backdoor inspection method, and a non-transitory computer readable medium capable of improving inspection efficiency for backdoors.

### BRIEF DESCRIPTION OF DRAWINGS

FIG. 1 is a block diagram showing an example of a backdoor inspection apparatus according to a first example embodiment;

FIG. 2 shows an example of a specifying unit of a backdoor inspection apparatus according to a second example embodiment;

FIG. 3 is a diagram for explaining a control flow graph;

FIG. 4 is a diagram for explaining an illegal path;

FIG. 5 is a diagram for explaining a hidden command;

FIG. 6 shows an example of a backdoor inspection apparatus according to a third example embodiment;

FIG. 7 shows an example of a backdoor inspection apparatus according to a fourth example embodiment;

FIG. 8 shows an example of an inspection result display;

FIG. 9 shows an example of an inspection result display;

FIG. 10 shows an example of an inspection result display;

FIG. 11 shows an example of an inspection result display;

FIG. 12 shows an example of a backdoor inspection apparatus according to a fifth example embodiment;

FIG. 13 shows an example of a backdoor inspection apparatus according to a sixth example embodiment;

FIG. 14 shows an example of a backdoor inspection apparatus according to a seventh example embodiment;

FIG. 15 is a flowchart showing an example of a processing operation of the backdoor inspection apparatus according to the seventh example embodiment;

FIG. 16 is a block diagram showing an example of a backdoor inspection apparatus according to another example embodiment <1>;

FIG. 17 is a block diagram showing an example of a backdoor inspection apparatus according to another example embodiment <2>;

FIG. 18 is a block diagram showing an example of a backdoor inspection apparatus according to another example embodiment <3>;

FIG. 19 is a block diagram showing an example of a backdoor inspection apparatus according to another example embodiment <4>;

FIG. 20 is a block diagram showing an example of a method of using a backdoor inspection apparatus according to another example embodiment <5>; and

FIG. 21 shows an example of a hardware configuration of a backdoor inspection apparatus.

### DESCRIPTION OF EMBODIMENTS

Example embodiments will be described below with reference to the drawings. In this example embodiment, the same or equivalent elements are denoted by the same reference signs, and repeated explanations are omitted.

### First Example Embodiment

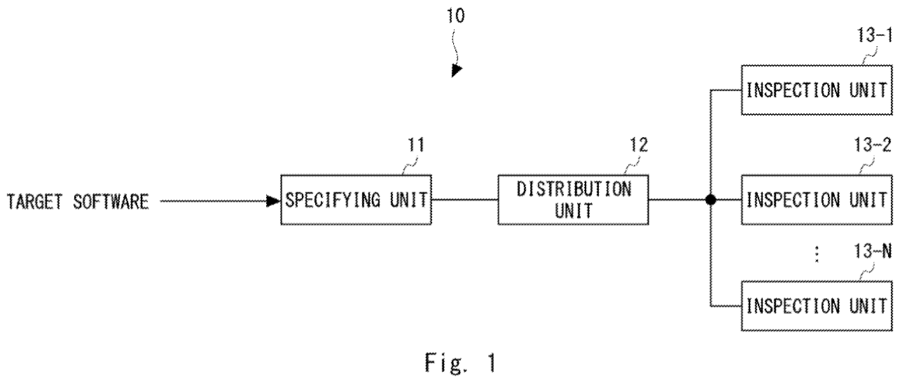

FIG. 1 is a block diagram showing an example of a backdoor inspection apparatus according to a first example embodiment. In FIG. 1, a backdoor inspection apparatus 10 includes a specifying unit 11, a distribution unit 12, and inspection units 13-1 to 13-N (N is a natural number of two or more). Hereinafter, when the inspection units 13-1 to 13-N are not distinguished from each other, the inspection units 13-1 to 13-N may be collectively referred to simply as inspection units 13.

The specifying unit 11 receives software to be inspected (hereinafter referred to simply as “target software”). The target software may be pre-compiled source code or compiled binary code. In the following description, it is mainly assumed that input software is binary code.

The specifying unit 11 specifies a plurality of functional blocks (i.e., code blocks) respectively corresponding to a plurality of functions included in the target software. The plurality of functions included in the target software may include, for example, an authentication function, an authorization function, a command parser function, and a communication function.

The distribution unit 12 inputs each functional block specified by the specifying unit 11 to at least some of the inspection units 13-1 to 13-N according to the function corresponding to each functional block specified by the specifying unit 11. The distribution unit 12 may use, for example, a “distribution rule table” in which a plurality of functions included in the target software and one or more inspection units 13 corresponding to the respective functions are associated with each other, to distribute the functional blocks specified by the specifying unit 11.

The inspection units 13-1 to 13-N execute inspection processing for backdoors of different types. That is, each inspection unit 13 executes the inspection processing on the functional block received from the distribution unit 12 using an inspection method corresponding to each inspection unit 13. Examples of the type of the backdoor include “hidden account”, “authentication bypass”, and “illegal function (information leakage function, kill switch, etc.)”.

As described above, according to the first example embodiment, in the backdoor inspection apparatus 10, the specifying unit 11 specifies a plurality of functional blocks respectively corresponding to a plurality of functions included in the target software. The inspection units 13-1 to 13-N execute the inspection processing for backdoors of different types. The distribution unit 12 inputs each functional block specified by the specifying unit 11 to at least some of the inspection units 13-1 to 13-N according to the function corresponding to each functional block specified by the specifying unit 11.

The inspection efficiency for backdoors can be improved with such a configuration of the backdoor inspection apparatus 10. That is, it is considered that there is a correlation between the type of the function included in the target software and the type of the backdoor embedded in this function. Therefore, the distribution unit 12 inputs each functional block specified by the specifying unit 11 to the inspection unit 13 which executes the inspection processing for the type of backdoor having high correlation with the function corresponding to the functional block. On the other hand, the distribution unit 12 does not input each functional block specified by the specifying unit 11 to the inspection unit 13 which executes the inspection processing for the type of backdoor having low correlation with the function corresponding to the functional block. In this way, wasteful inspection processing can be avoided, thereby improving the inspection efficiency for backdoors. In addition, since all of the inspection units 13-1 to 13-N share the specifying unit 11, the processing efficiency can be improved as compared to when the specifying processing for each inspection processing individually is performed.

In the above description, the inspection unit 13 executes the inspection processing on the functional block received from the distribution unit 12. Alternatively, the inspection unit 13 may inspect the entire software or the plurality of functional blocks. In such a case, the distribution unit 12 may pass the information about the entire software or some of the functional blocks to the inspection unit 13, and the inspection unit 13 may inspect the entire software or the plurality of functional blocks based on the information about the functional blocks.

### Second Example Embodiment

A second example embodiment relates to an example of the configuration of the specifying unit.

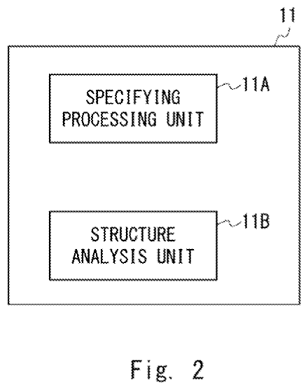

FIG. 2 shows an example of a specifying unit of a backdoor inspection apparatus according to the second example embodiment. A basic configuration of the backdoor inspection apparatus according to the second example embodiment is the same as that of the backdoor inspection apparatus 10 according to the first example embodiment, and will be described with reference to FIG. 1.

The backdoor inspection apparatus 10 according to the second example embodiment includes a specifying unit 11, a distribution unit 12, and inspection units 13-1 to 13-N (N is a natural number of two or more).

As shown in FIG. 2, the specifying unit 11 includes a specifying processing unit 11A and a structure analysis unit 11B.

The specifying processing unit 11A specifies a “predetermined functional block” corresponding to a “predetermined function” in target software. The “predetermined function” is, for example, an “interface function”, an “authentication function (authentication routine)”, and a “command parser function (parser routine)”. That is, the “predetermined function” is a function followed by various functions. Specifically, the “predetermined function” corresponds to the functional block which becomes a starting point in a control flow graph for the target software.

The specifying processing unit 11A may specify the predetermined functional block using, for example, a “specifying rule table (“a first specifying table”)” in which a plurality of predetermined functions are associated with features of predetermined functional blocks corresponding to the respective predetermined functions. In this case, the specifying processing unit 11A specifies, as the predetermined functional block, a part of the target software that matches the features of each predetermined functional block held in the specifying rule table. Alternatively, instead of the table, the specifying processing unit 11A may execute one or more algorithms or modules for specifying the predetermined function in order to specify the predetermined functional block.

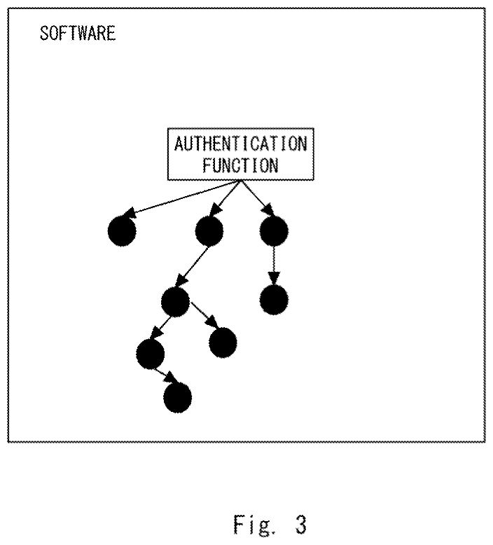

The structure analysis unit 11B analyzes a structure of the target software and specifies a functional block corresponding to a function other than the predetermined function by tracing the control flow starting from the predetermined functional block specified by the specifying processing unit 11A. For example, the structure analysis unit 11B creates a control flow graph as shown in FIG. 3 by tracing the control flow starting from the functional block of the authentication function specified by the specifying processing unit 11A. The structure analysis unit 11B uses the “specifying rule table (“a second specifying table”)” to specify the functional block corresponding to the function other than the predetermined function. In the “second specifying table”, the types of the functional block serving as the starting points are associated with the features of the specific target functional block to be specified according to the type. For example, in the “second specifying table”, a “functional block present after passing through the authentication routine in the control flow graph” is associated with a “functional block of the authentication function”, which is a code block serving as the starting point, as the “feature of the specific target functional block”. For example, in the “second specifying table”, a “functional block including a command or a function dispatched by a parser” is associated with a “functional block of the command parser function”, which is the functional block serving as the starting point as the “feature of the specific target functional block”. Note that in the control flow graph shown in FIG. 3, the “functional block of the authentication function” and the “specific target functional block (indicated by circles in FIG. 3)” may be referred to as “nodes”. In the control flow graph shown in FIG. 3, the arrows correspond to the control flows.

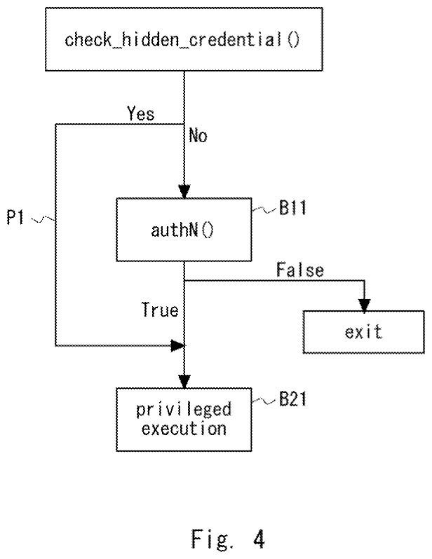

The inspection units 13-1 to 13-N include, for example, an inspection unit 13 for executing the inspection processing for a backdoor of “authentication bypass”. Here, it is assumed that the inspection unit 13-1 executes the inspection processing for a backdoor of “authentication bypass”. In this case, as shown in FIG. 4, the inspection unit 13-1 detects a “path (illegal path) P1” leading to a functional block B21 (i.e., a part of execution that needs to be authenticated) specified by the structure analysis unit 11B without passing through an authentication functional block B11 in the control flow graph created by the structure analysis unit 11B.

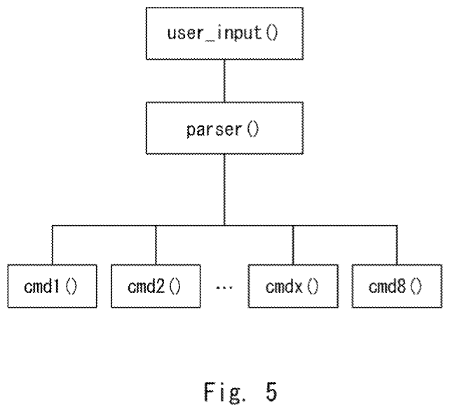

The inspection units 13-1 to 13-N include, for example, the inspection unit 13 for executing the inspection processing for a backdoor of a “hidden command”. Here, it is assumed that the inspection unit 13-2 executes the inspection processing for the backdoor of the “hidden command”. In this case, as shown in FIG. 5, the inspection unit 13-1 detects a functional block including a command (or function) not described in the specification in the control flow graph created by the structure analysis unit 11B. In the example of FIG. 5, since the command corresponding to a functional block “cmdx ( )” is not described in the specification, the functional block “cmdx ( )” is detected.

In this example, the distribution unit 12 distributes functional blocks (and the control flow graph) starting from the “functional block of the authentication function” specified by the specifying unit 11 to at least the inspection unit 13-1. Further, the distribution unit 12 distributes functional blocks (and the control flow graph) starting from the “functional block of the command parser function” specified by the specifying unit 11 to at least the inspection unit 13-2.

### Third Example Embodiment

A third example embodiment relates to checking for a presence or absence of a security measure and generating an inspection result report.

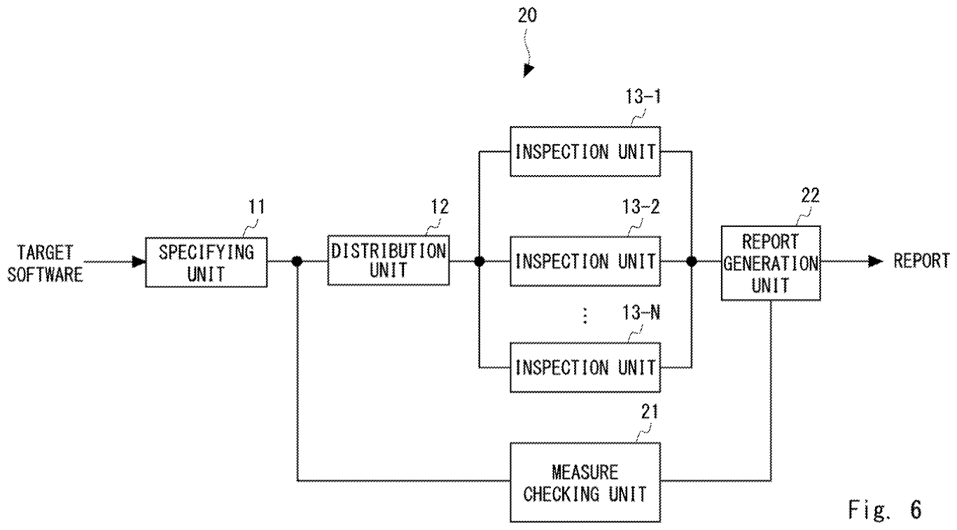

FIG. 6 shows an example of the backdoor inspection apparatus according to the third example embodiment. In FIG. 6, a backdoor inspection apparatus 20 includes a specifying unit 11, a distribution unit 12, inspection units 13-1 to 13-N (N is a natural number of two or more), a measure checking unit 21, and a report generation unit 22.

The measure checking unit 21 checks (determines) for the presence or absence of the “security measure” for the functional block (i.e., the block to be inspected) specified by the specifying unit 11. For example, the measure checking unit 21 checks (determines) for the presence or absence of the “security measure” for the block to be inspected using a “check rule table” that defines “checkpoints” for the security measures. For example, in the “check rule table”, a “presence or absence of a stack canary”, “whether or not a function having a high possibility of causing a vulnerability is used”, and so on are defined as the checkpoints. The stack canary is a measure for detecting a stack overflow. A function that has a high possibility for causing a vulnerability is, for example, “strcpy”.

The measure checking unit 21 associates identification information of the block to be inspected with a “risk index” corresponding to the presence or absence of the security measure, and outputs the identification information associated with the risk index to the report generation unit 22. The “risk index” may be a score indicating a risk (the higher the risk, the higher the score becomes) or a flag (bit) indicating a high risk.

The report generation unit 22 generates an “inspection result report”. For example, the “inspection result report” includes identification information of each functional block inspected by the inspection units 13-1 to 13-N, an inspection result (a presence or absence of a backdoor, etc.) of each functional block, and the risk index of each functional block in association with each other.

### Fourth Example Embodiment

A fourth example embodiment relates to display control of inspection results.

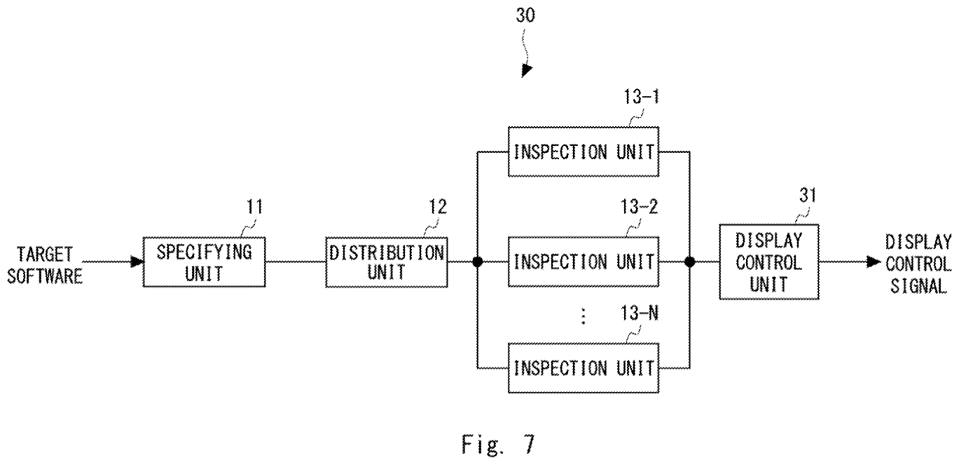

FIG. 7 shows an example of a backdoor inspection apparatus according to the fourth example embodiment. In FIG. 7, a backdoor inspection apparatus 30 includes a specifying unit 11, a distribution unit 12, inspection units 13-1 to 13-N (N is a natural number of two or more), and a display control unit 31.

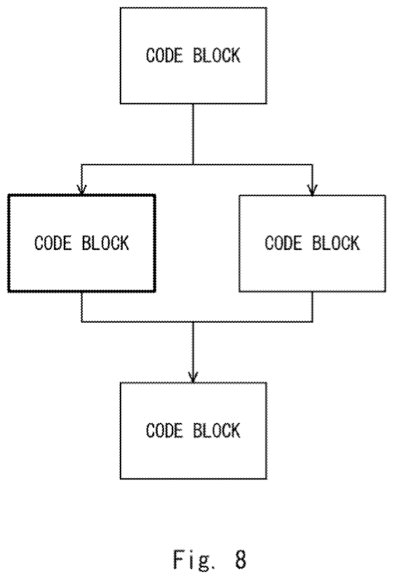

For example, as shown in FIG. 8, the display control unit 31 may execute control for displaying, on a display apparatus (not shown), the control flow graph obtained by the analysis on the structure of the software performed by the specifying unit 11 in a state where the functional block corresponding to the backdoor detected by the inspection processing by the inspection units 13-1 to 13-N is highlighted. FIG. 8 shows an example of the inspection result display. In FIG. 8, the code block highlighted by the thick frame is a functional block corresponding to the backdoor.

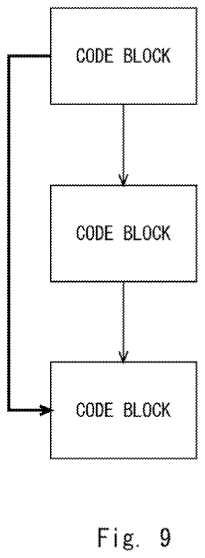

Further, as shown in FIG. 9, for example, the display control unit 31 may execute control for displaying, on the display apparatus (not shown), the control flow graph obtained by the analysis on the structure of the software performed by the specifying unit 11 in a state where the control flow corresponding to the backdoor detected by the inspection processing by the inspection units 13-1 to 13-N is highlighted. FIG. 9 shows an example of the inspection result display. In FIG. 9, a thick arrow indicates a control flow corresponding to the backdoor.

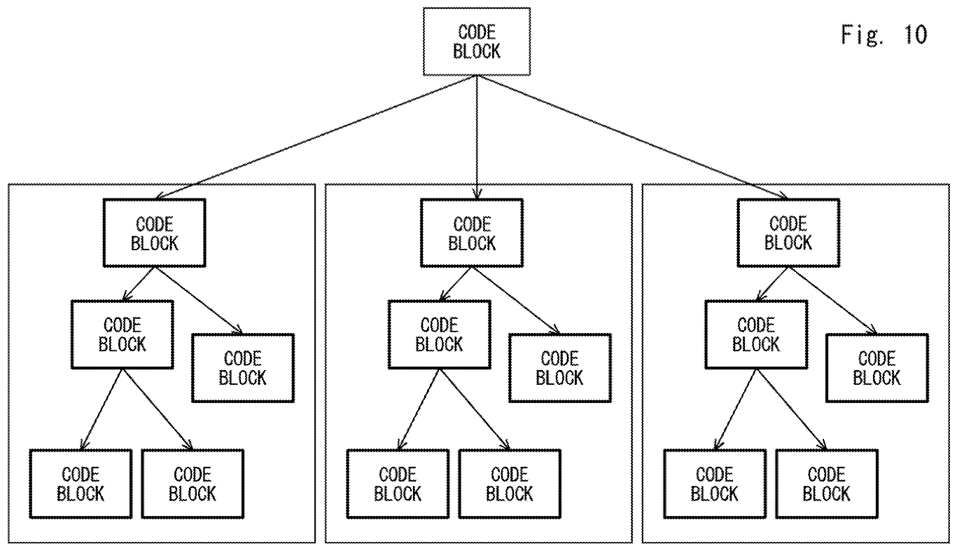

When the control flow graph is displayed, the display control unit 31 may display the control flow graph in a state where code blocks are grouped by function, and the groups are highlighted by a frame or color, as shown in FIG. 10. FIG. 10 shows an example of the inspection result display. In FIG. 10, the groups are highlighted by the frames.

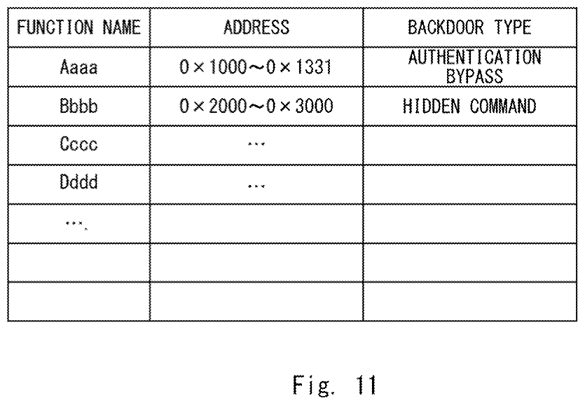

Further, as shown in FIG. 11, the display control unit 31 may display the inspection result in the form of a table in which function names corresponding to the backdoors, addresses, and backdoor types are associated with each other. FIG. 11 shows an example of the inspection result display.

### Fifth Example Embodiment

A fifth example embodiment relates to determination of a degree of intention and generation of an inspection result report. Specifically, there are two types of backdoors, one is intentionally embedded backdoors and the other is embedded due to a mistake made by a developer. Thus, the degree of intention indicating the possibility of the former type of backdoor is determined.

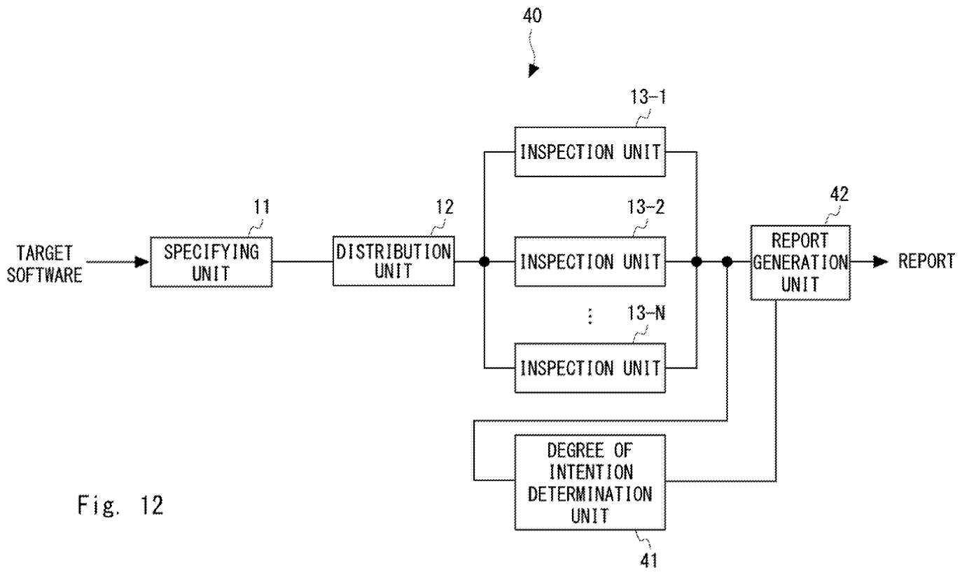

FIG. 12 shows an example of a backdoor inspection apparatus according to the fifth example embodiment. In FIG. 12, a backdoor inspection apparatus 40 includes a specifying unit 11, a distribution unit 12, inspection units 13-1 to 13-N (N is a natural number of two or more), a degree of intention determination unit 41, and a report generation unit 42.

The degree of intention determination unit 41 determines the “degree of intention” of the backdoor detected by the inspection units 13-1 to 13-N. For example, the degree of intention determination unit 41 determines the “degree of intention” of the backdoor detected by the inspection units 13-1 to 13-N using a “degree of intention determination table” that defines cases where the degree of intention of the backdoor is high. If a trace of concealing the backdoor is found, it is presumed that the intention of the backdoor is high. Examples of backdoor concealment include obfuscation of an execution code and complexity of a trigger for executing a backdoor. Backdoors that are triggered by bugs which can be easily detected, even if they are bug-based, are presumed to be highly intentional. For this reason, the “degree of intention determination table” may define “a case of obfuscated execution code”, “a case of a complex trigger for executing a backdoor”, and “a case of a trigger of a bug which can be easily detected” as cases in which the backdoor is highly intentional.

The degree of intention determination unit 41 associates the identification information of the functional block for which the degree of intention is to be determined with an index of the degree of intention (a degree of intention index) determined about the functional block to be determined, and outputs the identification information associated with the index of the degree of intention to the report generation unit 42.

The report generation unit 42 generates an “inspection result report”. For example, the “inspection result report” includes the identification information of each functional block inspected by the inspection units 13-1 to 13-N and an inspection result (a presence or absence of a backdoor, etc.) of each functional block in association with each other. Further, in the “inspection result report”, the degree of intention index is associated with the identification information of the functional block determined to be the backdoor. The degree of intention index may be a score indicating the degree of intention (the higher the intention, the higher the score becomes) or a flag (bit) indicating that the degree of intention is high.

### Sixth Example Embodiment

When the entire target software is inspected, it may take a long time for the inspection. Therefore, in sixth and seventh example embodiments, by omitting (skipping) inspection of the entire or a part of highly trusted software, the time required for inspection is reduced.

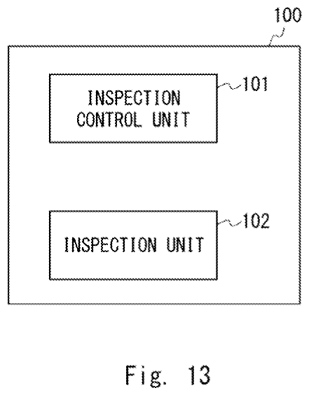

FIG. 13 shows an example of a backdoor inspection apparatus according to the sixth example embodiment. In FIG. 13, a backdoor inspection apparatus 100 includes an inspection control unit 101 and an inspection unit 102.

The inspection control unit 101 controls whether or not a functional block on which input control is to be performed (hereinafter referred to as “target functional block”) is input to the inspection unit 102 according to “trust (degree of trust)” of the functional block. The “target functional block” is a functional block corresponding to a function included in software to be inspected (hereinafter sometimes referred to as “target software”). Specifically, if the trust of the target functional block is high, the inspection control unit 101 does not cause the target functional block to be input to the inspection unit 102, whereas if the trust of the target functional block is low, the inspection control unit 101 causes the target functional block to be input to the inspection unit 102. In this manner, the inspection of a part of the software to be inspected can be omitted, thereby reducing the time required for the inspection.

The inspection unit 102 executes the inspection processing for a backdoor on the input target functional block. The inspection unit 102 may include the distribution unit 12 and the inspection units 13-1 to 13-N (N is a natural number of two or more) described in the first to fifth example embodiments.

As described above, according to the sixth example embodiment, in the backdoor inspection apparatus 100, the inspection control unit 101 controls whether or not to input the target functional block to the inspection unit 102 according to the trust of the target functional block.

With such a configuration of the backdoor inspection apparatus 100, the inspection of a part of the software to be inspected can be omitted, thereby reducing the time required for the inspection.

### Seventh Example Embodiment

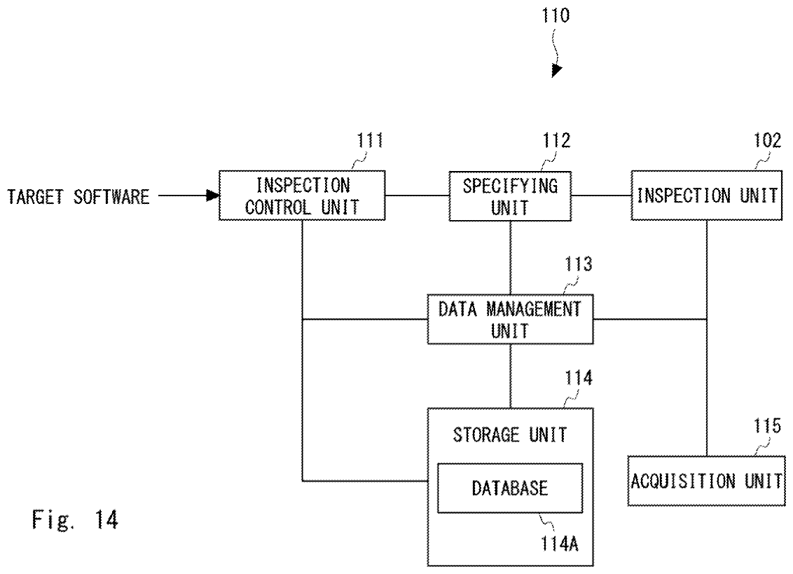

FIG. 14 shows an example of a backdoor inspection apparatus according to a seventh example embodiment. In FIG. 14, a backdoor inspection apparatus 110 includes an inspection control unit 111, a specifying unit 112, a data management unit 113, a storage unit 114, an acquisition unit 115, and an inspection unit 102.

The inspection control unit 111 controls whether or not to input the target software to the specifying unit 112 based on a database 114A stored in the storage unit 114. The database 114A includes a table holding digital signatures of software. For example, when a digital signature matching a digital signature of the target software is not held in the database 114A, the inspection control unit 111 inputs the software to be inspected to the specifying unit 112. On the other hand, when a digital signature matching the digital signature of the target software is held in the database 114A, the inspection control unit 111 does not input the target software to the specifying unit 112. That is, the inspection control unit 111 inputs the target software having low trust to the specifying unit 112, and does not input the target software having high trust to the specifying unit 112. By doing so, the inspection of the target software having high trust can be omitted.

The database 114A may include a table that holds the hash values of the entire software in which no backdoor has been detected by previous inspections performed by the inspection unit 102. In this case, the inspection control unit 111 calculates the hash values of the entire target software. Then, if there is no hash value matching the calculated hash values of the entire target software in the database 114A, the inspection control unit 111 inputs the target software to the specifying unit 112. On the other hand, if there is a hash value matching the calculated hash values of the entire target software in the database 114A, the inspection control unit 111 does not input the target software to the specifying unit 112. That is, the inspection control unit 111 inputs the target software having low trust to the specifying unit 112, and does not input the target software having high trust to the specifying unit 112. By doing so, the inspection of the target software having high trust can be omitted.

The specifying unit 112 specifies a plurality of functional blocks (i.e., the code blocks) corresponding to a plurality of functions included in the target software in a manner similar to the specifying unit 11 described in the first to fifth example embodiments.

The inspection control unit 111 determines whether or not each functional block specified by the specifying unit 112 (hereinafter referred to as a “target functional block”) has been inspected. If the target functional block has not been inspected, the inspection control unit 111 causes the target functional block to be input to the inspection unit 102. On the other hand, if the target functional block has been inspected, the inspection control unit 111 does not cause the target functional block to be input to the inspection unit 102. For example, the database 114A includes a table that holds hash values of functional blocks in which no backdoor has been detected by previous inspections performed by the inspection unit 102. The inspection control unit 111 calculates a hash value of each functional block specified by the specifying unit 112 (hereinafter referred to as a “target functional block”). Next, if there is no hash value matching the calculated hash value in the database 114A, the inspection control unit 111 determines that the target functional block has not been inspected. On the other hand, if there is a hash value matching the calculated hash value in the database 114A, the inspection control unit 111 determines that the target functional block has been inspected. That is, if the trust of the target functional block is high, the inspection control unit 111 does not cause the target functional block to be input to the inspection unit 102, whereas if the trust of the target functional block is low, the inspection control unit 111 causes the target functional block to be input to the inspection unit 102. In this manner, the inspection of a part of the software to be inspected can be omitted, thereby reducing the time required for the inspection.

The database 114A may also include a table that holds the digital signatures of the functional blocks. In this case, when a digital signature matching the digital signature of the target functional block is not held in the database 114A, the inspection control unit 111 causes the inspection unit 102 to be input to the target functional block. On the other hand, when a digital signature matching the digital signature of the target functional block is held in the database 114A, the inspection control unit 111 does not cause the target functional block to be input to the inspection unit 102. That is, if the trust of the target functional block is high, the inspection control unit 111 does not cause the target functional block to be input to the inspection unit 102, whereas if the trust of the target functional block is low, the inspection control unit 111 causes the target functional block to be input to the inspection unit 102. In this manner, the inspection of a part of the software to be inspected can be omitted, thereby reducing the time required for the inspection. Further, since code blocks used in a plurality of products (software) are inspected only once at the time of inspecting one piece of software, the time required for the inspection can be reduced. Further, when the updated/upgraded software is inspected, only a functional block corresponding to the difference from the pre-updated/pre-upgraded software is inspected, so that the time required for the inspection can be reduced.

The data management unit 113 manages the database 114A stored in the storage unit 114. For example, the data management unit 113 registers, in the database 114A, the digital signature of the software acquired from outside of the backdoor inspection apparatus 110 by the acquisition unit 115. The data management unit 113 calculates the hash values of the entire software in which no backdoor is detected by the inspection unit 102, and registers the calculated hash values in the database 114A. The data management unit 113 also calculates a hash value of the functional block in which no backdoor is detected by the inspection unit 102, and registers the calculated hash value in the database 114A. Further, the data management unit 113 registers, in the database 114A, the digital signature of the functional block acquired from the outside of the backdoor inspection apparatus 110 by the acquisition unit 115.

Furthermore, the data management unit 113 may register information about each functional block specified by the specifying unit 112 in the database 114A. The data management unit 113 may register a control flow graph created by the specifying unit 112 in the database 114A. The information about each of these functional blocks and the control flow graph are intermediate data of the analysis of the target software.

The data management unit 113 may register information about a creator of the software or code block as metadata in the database 114A. Based on this information, the inspection control unit 111 may determine the trust of the target software and the target functional block.

In addition, the data management unit 113 may register information related to instructions and API calls requiring authority in the database 114A as the metadata.

The data management unit 113 may also register, in the database 114A as the metadata, a blacklist including information about a code block which is a backdoor acquired from the outside of the backdoor inspection apparatus 110 by the acquisition unit 115. Based on this information, the inspection control unit 111 may determine the trust of the target functional block.

The data management unit 113 may further register a list including information about functions having the same meaning (e.g., string comparison) in the database 114A as the metadata. The specifying unit 112 may use this information to specify the functional block.

In the above descriptions, the data management unit 113, the storage unit 114, and the acquisition unit 115 have been described as being included in the backdoor inspection apparatus 110, but this example embodiment is not limited to this. For example, the data management unit 113, the storage unit 114, and the acquisition unit 115 may be provided in a server (not shown) that is separate from the backdoor inspection apparatus 110 and is communicable with the backdoor inspection apparatus 110.

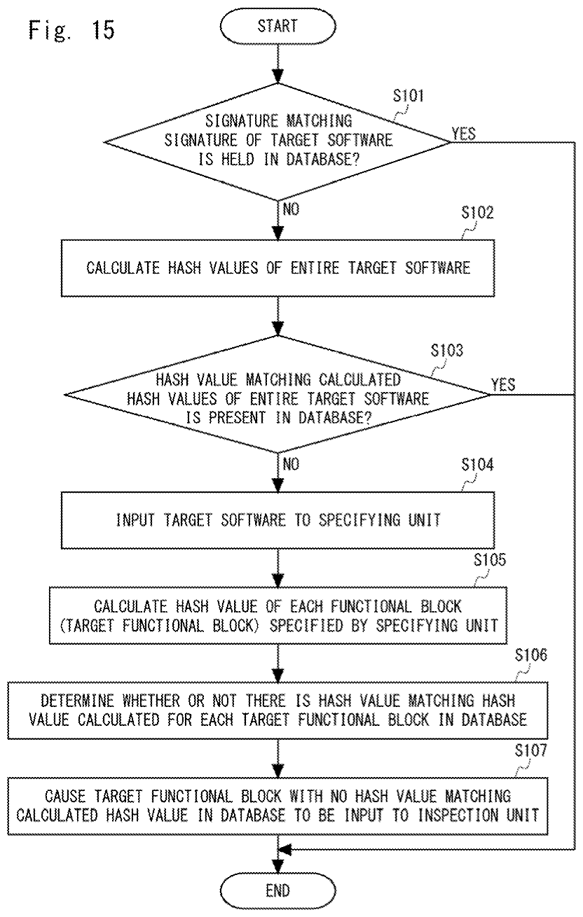

An example of a processing operation of the backdoor inspection apparatus 110 having the above configuration will be described. FIG. 15 is a flowchart showing an example of the processing operation of the backdoor inspection apparatus according to the seventh example embodiment. In particular, the input control performed by the inspection control unit 111 will be described. This flowchart starts, for example, when the target software is input to the inspection control unit 111.

The inspection control unit 111 determines whether a digital signature matching the digital signature of the target software is held in the database 114A (Step S101).

If the digital signature matching the digital signature of the target software is held in the database 114A (YES in Step S101), the inspection control unit 111 does not input the target software to the specifying unit 112, and the processing flow ends.

If the digital signature matching the digital signature of the target software is not held in the database 114A (NO in Step S101), the inspection control unit 111 calculates the hash values of the entire target software (Step S102).

The inspection control unit 111 determines whether or not there is a hash value matching the calculated hash values of the entire target software in the database 114A (Step S103).

If there is a hash value matching the calculated hash values of the target software in the database 114A (YES in Step S103), the inspection control unit 111 does not input the target software to the specifying unit 112, and the processing flow ends. At this time, when the backdoor inspection apparatus includes the report generation unit 22 as in the third example embodiment, the inspection control unit 111 may control the backdoor inspection apparatus 110 to generate an inspection result report including the previous inspection results of the target software held in the database 114A.

If there is no hash value in the database 114A matching the calculated hash values of the entire target software (NO in Step S103), the inspection control unit 111 inputs the target software to the specifying unit 112 (Step S104). In this way, the specifying unit 112 specifies a plurality of functional blocks respectively corresponding to a plurality of functions included in the input target software.

The inspection control unit 111 calculates a hash value of each functional block (the target functional block) specified by the specifying unit 112 (Step S105).

The inspection control unit 111 determines whether or not there is a hash value matching the hash value calculated for each target functional block in the database 114A (Step S106).

The inspection control unit 111 causes the target functional block with no hash value matching the calculated hash value in the database 114A to be input to the inspection unit 102 (Step S107).

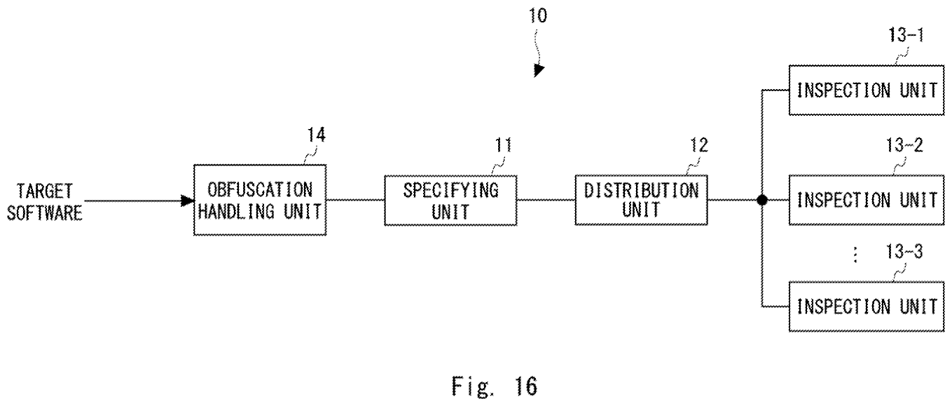

### Other Example Embodiments

<1> Software is often obfuscated. In order to handle the obfuscation, the backdoor inspection apparatus according to the first to fifth example embodiments may include an obfuscation handling unit. FIG. 16 is a block diagram showing an example of a backdoor inspection apparatus according to another example embodiment <1>. FIG. 16 shows a configuration of the backdoor inspection apparatus when the backdoor inspection apparatus according to the first example embodiment includes the obfuscation handling unit.

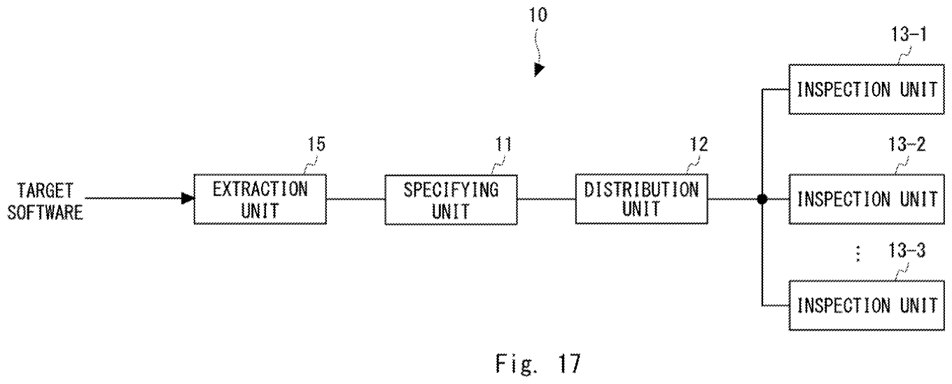

In the backdoor inspection apparatus 10 shown in FIG. 16, the obfuscation handling unit 14 executes processing for removing the obfuscation of the target software and outputs the target software from which the obfuscation has been removed to the specifying unit 11.

<2> If the target software is firmware of a device, it is necessary to extract a program from the firmware. For this reason, an extraction unit for extracting a program from the firmware may be provided in the backdoor inspection apparatus according to the first to fifth example embodiments. FIG. 17 is a block diagram showing an example of a backdoor inspection apparatus according to another example embodiment <2>. FIG. 17 shows a configuration of a backdoor inspection apparatus when the backdoor inspection apparatus according to the first example embodiment includes an extraction unit.

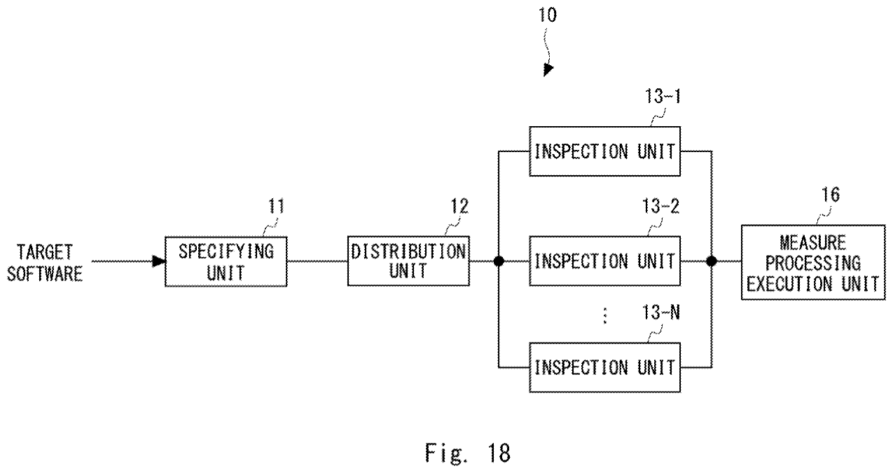

In the backdoor inspection apparatus 10 shown in FIG. 17, the extraction unit 15 extracts a program from the firmware that is the target software, and outputs the extracted program to the specifying unit 11. The specifying unit 11 performs processing on the program. For example, the extraction unit 15 may extract a program from the firmware using a tool such as binwalk or foremost.

<3> The backdoor inspection apparatus according to the first to fifth example embodiments may include a measure processing execution unit for executing measure processing for the detected backdoor. FIG. 18 is a block diagram showing an example of a backdoor inspection apparatus according to another example embodiment <3>. FIG. 18 shows a configuration of the backdoor inspection apparatus when the backdoor inspection apparatus according to the first example embodiment includes the measure processing execution unit.

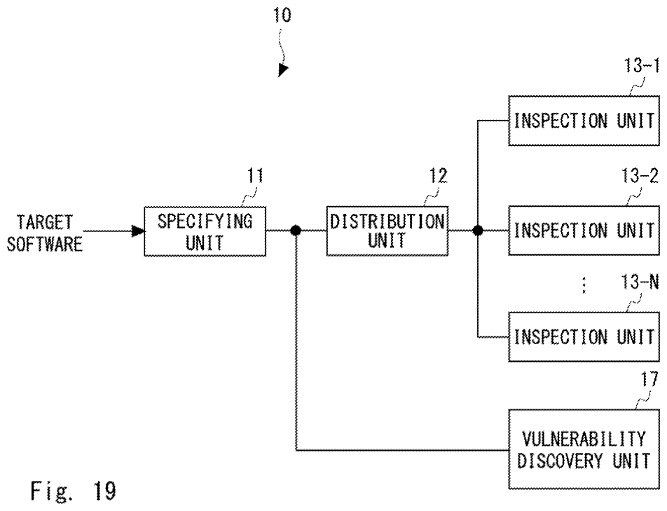

The measure processing execution unit 16 may perform processing for removing the backdoor detected by the inspection units 13-1 to 13-N from the target software. Alternatively, the measure processing execution unit 16 may perform processing to issue an alert when the backdoor is detected by the inspection units 13-1 to 13-N.

<4> The backdoor inspection apparatus according to the first to fifth example embodiments may include a vulnerability discovery unit in order to provide a measure against a bug-based backdoor. FIG. 19 is a block diagram showing an example of a backdoor inspection apparatus according to another example embodiment <4>. FIG. 19 shows a configuration of a backdoor inspection apparatus when the backdoor inspection apparatus according to the first example embodiment is provided with a vulnerability discovery unit.

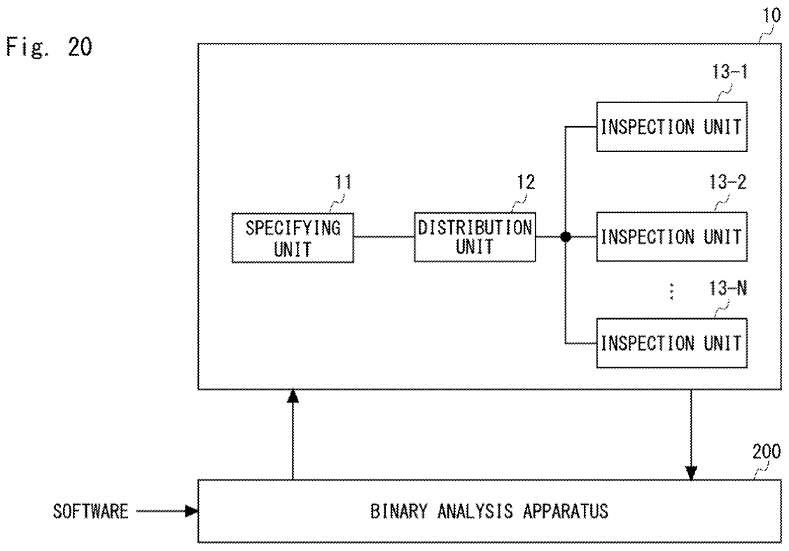

The vulnerability discovery unit 17 searches for a vulnerable part in each functional block specified by the specifying unit 11 using an existing vulnerability discovery method. Information about the vulnerable part discovered by the vulnerability discovery unit 17 may be included in the inspection result report.

<5> The backdoor inspection apparatus according to the first to fifth example embodiments may be used as a plug-in of a binary analysis apparatus. FIG. 20 is a block diagram showing an example of a method of using a backdoor inspection apparatus according to another example embodiment <5>. FIG. 20 shows, as an example, a case where the backdoor inspection apparatus according to the first example embodiment is used as a plug-in.

A binary analysis apparatus 200 analyzes input software using a binary analysis tool such as IDA Pro or Ghidra. For example, the binary analysis apparatus 200 disassembles (or decompiles) the input software and outputs the disassembled (or decompiled) binary or code block to the backdoor inspection apparatus 10. The binary analysis apparatus 200 may also output information about an authentication routine, a parser, or the like to the backdoor inspection apparatus 10.

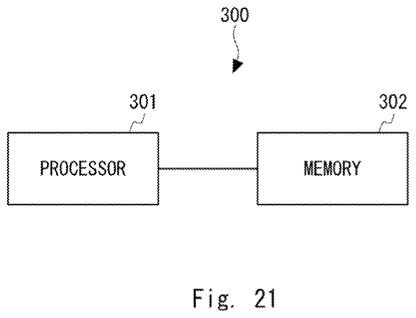

The backdoor inspection apparatus 10 outputs information about the code block determined to include the backdoor or information about the control flow corresponding to authentication bypass to the binary analysis apparatus 200.

<6> FIG. 21 shows an example of a hardware configuration of the backdoor inspection apparatus. In FIG. 21, a backdoor inspection apparatus 300 includes a processor 301 and a memory 302. The processor 301 may be, for example, a microprocessor, a MPU (Micro Processing Unit), or a CPU (Central Processing Unit). The processor 301 may include a plurality of processors. The memory 302 is composed of a combination of a volatile memory and a non-volatile memory. The memory 302 may include a storage separated from the processor 301. In this case, the processor 301 may access the memory 302 through an I/O interface (not shown).

The backdoor inspection apparatuses 10, 20, 30, 40, 100, and 110 according to the first to seventh example embodiments and another example embodiment <1> to another example embodiment <5> may each have the hardware configuration shown in FIG. 21. The specifying units 11 and 112, the distribution unit 12, the inspection units 13 and 102, the obfuscation handling unit 14, the extraction unit 15, the measure processing execution unit 16, the vulnerability discovery unit 10, the measure checking unit 20, the report generation units 30 and 40, 100, and 110, the display control unit 31, the degree of intention determination unit 41, the inspection control units 101 and 111, the data management unit 113, and the acquisition unit 115 of the backdoor inspection apparatuses 10, 20, 30, 40, 100, and 110 according to the first to seventh example embodiments and another example embodiment <1> to another example embodiments <5> may be implemented by the processor 301 reading and executing a program stored in the memory 302. The storage unit 114 may be implemented by the memory 302. The program can be stored and provided to the backdoor inspection apparatuses 10, 20, 30, 40, 100, and 110 using any type of non-transitory computer readable media. Examples of non-transitory computer readable media include magnetic storage media (such as floppy disks, magnetic tapes, hard disk drives, etc.), optical magnetic storage media (e.g. magneto-optical disks). Examples of non-transitory computer readable medium further include CD-ROM (Read Only Memory), CD-R, and CD-R/W. Examples of non-transitory computer readable medium further include semiconductor memories. Examples of semiconductor memories include mask ROM, PROM (Programmable ROM), EPROM (erasable PROM), flash ROM, RAM (random access memory), etc. The program may be provided to the backdoor inspection apparatuses 10, 20, 30, 40, 100, and 110 using any type of transitory computer readable media. Examples of transitory computer readable media include electric signals, optical signals, and electromagnetic waves. Transitory computer readable media can provide the program to the backdoor inspection apparatuses 10, 20, 30, 40, 100, and 110 via a wired communication line (e.g. electric wires, and optical fibers) or a wireless communication line.

Although the present disclosure has been described with reference to the above example embodiments, the present disclosure is not limited to the above. Various changes can be made to the configuration and details of the disclosure within the scope of the disclosure that can be understood by those skilled in the art.

### REFERENCE SIGNS LIST

10 BACKDOOR INSPECTION APPARATUS
11 SPECIFYING UNIT
11A SPECIFYING PROCESSING UNIT
11B STRUCTURE ANALYSIS UNIT
12 DISTRIBUTION UNIT
13 INSPECTION UNIT
14 OBFUSCATION HANDLING UNIT
15 EXTRACTION UNIT
16 MEASURE PROCESSING EXECUTION UNIT
17 VULNERABILITY DISCOVERY UNIT
20 BACKDOOR INSPECTION APPARATUS
21 MEASURE CHECKING UNIT
22 REPORT GENERATION UNIT
30 BACKDOOR INSPECTION APPARATUS
31 DISPLAY CONTROL UNIT
40 BACKDOOR INSPECTION APPARATUS
41 DEGREE OF INTENTION DETERMINATION UNIT
42 REPORT GENERATION UNIT
100 BACKDOOR INSPECTION APPARATUS
101 INSPECTION CONTROL UNIT
102 INSPECTION UNIT
110 BACKDOOR INSPECTION APPARATUS
111 INSPECTION CONTROL UNIT
112 SPECIFYING UNIT
113 DATA MANAGEMENT UNIT
114 STORAGE UNIT
114A DATABASE
115 ACQUISITION UNIT

What is claimed is:

1. A backdoor inspection apparatus comprising:
hardware including at least one processor and at least one memory; specifying unit implemented at least by the hardware and that specifies a plurality of functional blocks respectively corresponding to a plurality of functions included in software to be inspected;
a plurality of inspection units implemented at least by the hardware and that execute inspection processing for each different type of backdoors on the input functional blocks; and
distribution unit implemented at least by the hardware and that inputs the specified functional blocks to at least some of the plurality of inspection units according to functions corresponding to the specified functional blocks.

2. The backdoor inspection apparatus according to claim 1, wherein
the specifying unit comprises:
specific processing unit implemented at least by the hardware and that specifies a predetermined functional block corresponding to a predetermined function in the software; and
structure analysis unit implemented at least by the hardware and that analyzes a structure of the software and specifying the functional block corresponding to a function other than the predetermined function by tracing a control flow starting from the specified predetermined functional block.

3. The backdoor inspection apparatus according to claim 2, wherein
the specific processing unit specifies the predetermined functional block using a specifying rule table, a plurality of the predetermined functions being associated with features of the predetermined functional block corresponding to each predetermined function in the specifying rule table.

4. The backdoor inspection apparatus according to claim 1, wherein
the distribution unit distributes each of the specified functional blocks using a distribution rule table, the plurality of functions being associated with the one or more inspection units corresponding to the respective functions in the distribution rule table.

5. The backdoor inspection apparatus according to claim 1, further comprising report generation unit implemented at least by the hardware and that generates a report including a result of the inspection processing on the functional block to be inspected.

6. The backdoor inspection apparatus according to claim 5, further comprising:
determination unit implemented at least by the hardware and that determines a presence or absence of a security measure for the functional block to be inspected using a check rule table defining a checkpoint for the security measure, wherein
the report generation unit includes, in the report, a risk index corresponding to the presence or absence of the security measure for the functional block to be inspected in association with the result of the inspection processing.

7. The backdoor inspection apparatus according to claim 2, further comprising:
display control unit implemented at least by the hardware and that executes control for displaying, on display unit, a control flow graph obtained by analyzing the structure of the software in a state where the functional block corresponding to the backdoor or the control flow corresponding to the backdoor detected in the inspection processing performed by the plurality of inspection units is highlighted.

8. A backdoor inspection method executed by a backdoor inspection apparatus, the backdoor inspection method comprising:
specifying a plurality of functional blocks respectively corresponding to a plurality of functions included in software to be inspected;
inputting the specified functional blocks to at least some of a plurality of inspection units of the backdoor inspection apparatus according to functions corresponding to the specified functional blocks; and
executing, by the plurality of inspection units, inspection processing for each different type of backdoors on the input functional blocks.

9. A non-transitory computer readable medium storing a program for causing a backdoor inspection apparatus to execute:
specifying a plurality of functional blocks respectively corresponding to a plurality of functions included in software to be inspected;
inputting the specified functional blocks to at least some of a plurality of inspection units of the backdoor inspection apparatus according to functions corresponding to the specified functional blocks; and
executing, by the plurality of inspection units, inspection processing for each different type of backdoors on the input functional blocks.
